(19) United States
(12) Patent Application Publication
(10) Pub. No.: US 2009/0266735 A1
(43) Pub. Date: Oct. 29, 2009

(54) Personalizable beverage bottle name label

(76) Inventor: Cherie Lynn Moore, Livemore, CA (US)

Correspondence Address: CHERIE LYNN MOORE, 1270 SPRUCE STREET, LIVEMORE, CA, 94551, US

(21) Appl. No.: 12/386,916

(22) Filed: Apr. 24, 2009

Related U.S. Application Data
(60) Provisional application No. 61/125,830, filed on Apr. 28, 2008.

(51) Int. Cl. B65D 85/00; B42D 15/00

(52) U.S. Cl. 206/459.5; 283/81

(57) ABSTRACT

This invention is a method of identifying the user of any beverage container by making available an empty marked out area on any existing beverage label for the sole purpose in which anyone can write their own personal name, initials or identification on to easily identify their own personal beverage. The specific area is added to the cylindrical beverage label that encompasses the beverage and the area made to fit in the label can be any size, shape, and distinction and made of any choice of label material to be chosen by any individual beverage, label company or corporation. The personalizable area of the label is incorporated into the layout and design of the label before printing and added to any area of the existing label that also contains identification of the container; such as the name of the beverage, itemization of ingredients, company name, barcode and recycling information.

This specification claims the benefit of the Provisional USPTO Application for Personalizable Beverage Bottle Name Label filed by Cherie Lynn Moore, Inventor. Provisional No. 61/125,830 Dated Apr. 28, 2008 claiming as priority date for this application.

### REFERENCES CITED

### U.S. Patent Documents

| | | | |
|---|---|---|---|
| 2,976,629 | March 1961 | Brixius et al | |
| 4,759,139 | July 1988 | Ricks | 40/310X |
| 5,301,802 | April 1994 | Nemeroff | |
| 5,358,770 | October 1994 | Evans | 40/310X |
| 5,704,144 | January 1998 | Groth | 40/306 |
| 4,901,457 | February 1990 | Chandler | 40/306 |
| 2,262,492 | November 1941 | Farrell | |
| 6,086,702 | July 2000 | Rea | 40/306 |

### BACKGROUND OF INVENTION

The Personalizable Beverage Bottle Name Label relates to improvements in the labeling of beverage bottles and primarily to an improved means to identify personal drinks, bottles and other containers. This invention simply provides a blank space within the already existing beverage label provided on the container for means to write consumers name on and thus be able to identify it.

Bottles and other beverage containers are utilized throughout the world everyday, and the growing concerns about the health and wellness of individuals has become an everyday concern for all of us. The need to identify one's own beverage is extremely important when mixed in with other like beverages with no means of identification.

Knowing that when two or more individuals set their bottle (or other container) of like appearance on a table or anywhere, it is often hard to identify which bottle belongs to which individual, and often results in one individual drinking from the bottle or container belonging to another individual. This intermixing of beverage bottles or containers is a potential health factor, poses a risk and contributes to un-cleanness and the possible spread of illness or disease.

Accordingly, it would be desirable to provide an improved method to enable an individual to be able to easily recognize or distinguish his or her beverage container after the beverage container has been intermixed with other containers of the same appearance.

### SUMMARY OF INVENTION

This invention Personalizable Beverage Bottle Name Label relates to a method and apparatus for easily identifying the user of a beverage bottle or container.

This invention allows the user to manually write their name on a pre-existing positioned label space within the existing bottle label, made of waterproof, and/or any writeable paper or any material of a pre-existing beverage label that is already attached to a beverage container for personalization by using any type of writing instrument.

This invention is easily implemented by any beverage or container company to add a block, square, strip or blank space where one is able to write their personal identification or name on the label. Any company can use any size label with any type of paper, plastic, waterproof, or writeable label space and add to any existing label design for the sole purpose to easily enable any consumer to write their personal name on the label and be able to readily identify their own beverage by providing this space for personal identification.

The purpose of this invention is to add any block, square, strip or other blank space of any shape or size to any pre-existing label of any label material anywhere on the beverage container or bottle, within the beverage label. This allows for a blank space or block in which any individual beverage or container company is free to choose where to put the blank space anywhere within their own label and use whatever kind of waterproof, writeable, or other material for their label that they would choose to use, thus adding it to their existing label, and incorporating the name space on their pre-existing labels and have them made through their own labeling machines or outsourced label companies.

### BRIEF DESCRIPTION OF THE DRAWINGS

FIG. 1 Is a rear view of beverage label, back side of label, block style space set out for name identification. This is placed in the back part of the label and is a horizontal space allowing for personal identification of the user on the back side of the label.

FIG. 2 Is a front view of the beverage label with the name strip space on the label along the bottom position for the purpose of name identification, thus allowing for personal identification of the user of the beverage container along the bottom of the label.

FIG. 3 Is a front view of the beverage label with the name spot label across the top of the label for the purpose of the users name identification, allowing for personalization of the user of the beverage container.

FIG. 4 Is a long or full view of the label only with a block name space set out for personalization of the individuals' name identification in the middle of the back label where the two ends meet, which is a usable space for a name identification space location.

### DESCRIPTION OF THE PREFERRED EMBODIMENTS

These are a few examples of locations for the Personalizable Beverage Bottle Name Labels, and this invention holds claim to adding any blank personalizable name label, spaces, blocks or whatever shape any individual company may choose to create and incorporate this into their own any size of pre-existing label design anywhere on their already existing beverage label with any type of label material that allows the consumer to personalize their beverage container on their own for their own benefit and identification purposes.

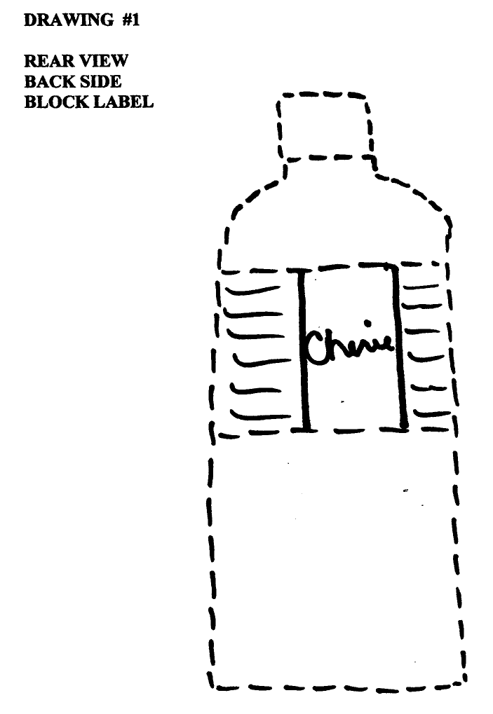

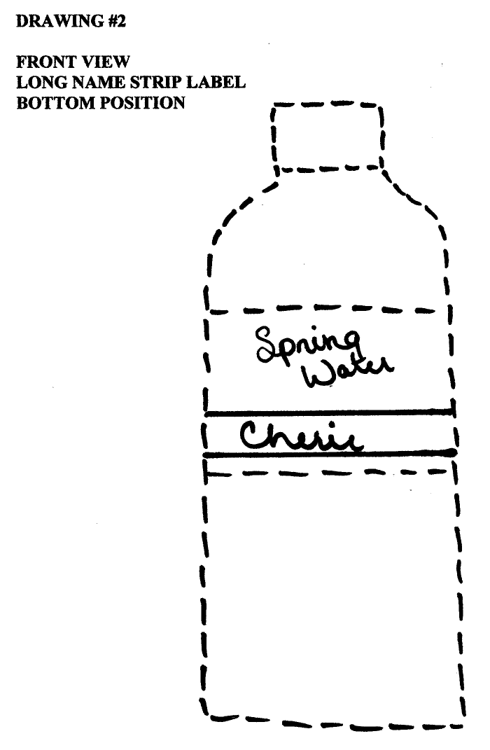

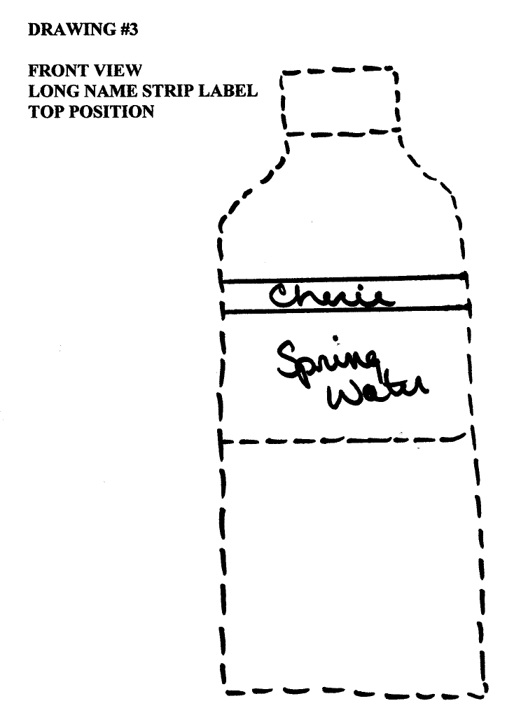

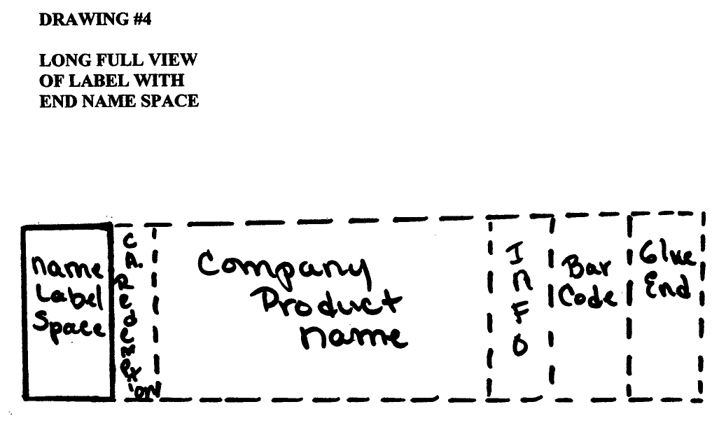

Referring now to the drawings, particularly FIGS. 1-4 thereof illustrate a preferred embodiment of the present invention, designating a blank space of any size or shape anywhere on a beverage label for the purpose of name identification and knowledge of ownership. Any beverage container bearing a label with the capacity for identification using any writing instrument for the express purpose of applying one's name to the object, bottle or container. This Personalizable Beverage Bottle Name Label space is added in the design and processing of any label design program and/or implementation in the process to the production of beverage bottle labels. It being understood that the label space for personalization is designed and processed and assembled to any pre-existing label in any suitable or conventional manner of making.

The purpose of this invention allows any one to be able to easily identify their own beverage bottle without any confusion or unnecessary gimmicks or props, and would help aid in the spread of diseases or illnesses with potential for health risks. Personalization of consumable beverages particularly beverages of like size and appearance, is highly necessary for the wellness and benefit of consumers of all ages. The ability to be able to easily identify and personalize one's own beverage bottle by being able to apply one's name to the containers' label helps eliminate the spread of germs, disease, and other illnesses from accidently or unknowingly drinking out of someone else's bottle and helps to end a universal problem of not being able to identify one's personal beverage container.

1. Providing a pre-existing blank space on any beverage bottle label for the purpose of personal identification.

2. May be of any size blank space in any shape, or form on a label with the ability to apply one's name or identification on.

3. May use any material suitable for labels and label manufacturing.
